(19) United States
(12) Patent Application Publication
(10) Pub. No.: US 2007/0096869 A1
(43) Pub. Date: May 3, 2007

(54) Work time recording system and method for recording work time

(76) Inventor: Stefan Trohler, Wohlenschwil (CH)

Correspondence Address: SEED INTELLECTUAL PROPERTY LAW GROUP PLLC, 701 FIFTH AVE, SUITE 5400, SEATTLE, WA, 98104, US

(21) Appl. No.: 10/562,076

(22) PCT Filed: Jun. 24, 2003
(86) PCT No.: PCT/CH03/00413

§ 371 Date: Dec. 22, 2005

(51) Int. Cl. G05B 19/00

(52) U.S. Cl. 340/5.52

(57) ABSTRACT

Proposed is a method and a system for work time recording in which a data recording client (10, . . . , 16) records biometric data and/or data on physical condition of the user (1), and transmits it together with the user data over a first communication channel (30/31) to the central unit (20/21). The user (1) is identified based on the transmitted biometric data and/or data on physical condition and biometric data and/or data on physical condition of users stored in the user database (40). The analyzed data are transmitted to a remuneration recording module (50), and are evaluated and/or checked by means of the remuneration recording module (50).

The present invention relates to a work time recording and work time monitoring method, or a corresponding monitoring and work time recording system, in which user data are recorded by a data recording client, and are transmitted to a central unit. Based on the user data, the user is identified by means of a user database, and with successful identification, time and/or place of capture of the user data are stored in a data record assigned to the user and/or further evaluated. The present invention relates in particular to a method and a system for recording work time involving access-controlled buildings or mobile users.

Diverse systems for recording work time are already known in the state of the art, and worldwide there are thousands of such systems in use. With these systems, a first work status, such as e.g. start of working time of a user, and a second work status, such as e.g. end of working time of a user, can be individually recorded and evaluated on a person-by-person basis. These systems usually work with a user identification, e.g. by means of magnetic card, user ID (ID: identification number) or a so-called stamp card, to ensure an unambiguous assignment of the work time to a particular employee or user. For recording the working time, the respective user has to enter the corresponding data in the system, for example by introducing a magnetic card into a magnetic card reader. In the last few decades, however, the working behavior of employees has changed drastically with respect to mobility, the requirements made of employees, such as e.g. state of health owing to liability issues, etc., and the requirements with respect to security against fraud, etc. Owing to the propagation of mobile calculating units, such as e.g. laptops, the emergence of worldwide operating networks, such as e.g. the worldwide backbone Internet or mobile radio networks, and owing to the globalization of companies, which requires great mobility of the employees, the conditions of employment today can no longer be compared with those of some years ago. The above-mentioned systems, however, are able to keep up with this development.

It is an object of the present invention, to propose a new and improved method and system for recording and monitoring work time which satisfies the present day requirements with respect to conditions of employment (mobility, physical prerequisites, etc.), user friendliness and security, and which in particular does not have the drawbacks mentioned above.

These objects are achieved according to the present invention in particular through the elements of the independent claims. Further advantageous embodiments follow moreover from the dependent claims and from the specification.

In particular, these objects are achieved by the invention in that user data are recorded by a data recording client, and are transmitted to a central unit via a first communication channel, based on which user data the user is identified by means of a user database, the data recording client recording biometric data and/or data on physical condition of the user by means of an input unit of the data recording client, and transmitting these data together with the user data via a first communication channel to the central unit, the central unit comparing the transmitted biometric data and/or data on physical condition with biometric data and/or data on physical condition of users stored in the user database, and a user being identified, by means of the central unit, if the probability of a correspondence of the transmitted biometric data to particular stored biometric data lies above a predefined threshold, whereby, with successful identification, at least one user status, assigned to a data record of the identified user, is modified and stored, based on time and/or place of capture of the user data, and the data records of the user are transmitted to a remuneration recording module, and are evaluated and/or checked by means of the remuneration recording module. The biometric data can comprise e.g. fingerprints, iris recognition, DNA analysis, etc. The data on physical condition can comprise, for example, body temperature, blood values (e.g. blood sugar, etc.), alcohol values, pulse, etc. The advantage of this invention is in particular that the work time recording and work time accounting as well as productivity calculations and performance recording for individual users can take place simply and efficiently. In particular, the user and/or employee does not need any identification cards for this purpose, such as e.g. magnetic cards, etc., control patches or the like. The system and method are therefore more economical and less error-prone. Thus neither do magnetic cards etc. need to be manufactured, nor is a personnel-intensive administration of the cards necessary. Likewise advantageous is that the employee can neither forget nor lose biometric features, in contrast to identification cards, etc., and the security against fraud (such as e.g. counterfeiting, forgery, theft of cards) is considerably increased. The same applies for an identification by means of user identification code (ID), which e.g. can easily be forgotten by the user and/or employee, or misused in a fraudulent way if the ID has been noted somewhere by the user, for example. The unambiguous and secure user identification can be important in particular in the billing for services or working hours of mobile working users and/or employees. Another advantage lies in the additional capturing of data on physical condition, whereby security in user identification can be increased, in that e.g. during scanning of the fingerprint, the body temperature of the finger and/or chemical/physical characteristics of the skin (skin tension, salt content, etc.) and/or pulse can be measured at the same time. Finger reproductions being used with the system in a fraudulent way can thereby be prevented, for example. Safety regulations, for instance, can also be controlled with respect to the user (e.g. alcohol content, for instance in the case of long distance truck drivers, body temperature in order to detect diseases, etc.).

In an embodiment variant, access to definable premises and/or use of definable devices is granted to the user by the central unit only with successful identification and authorization. This has the advantage, among others, that a central access control or respectively access control by the system takes place at the same time. This considerably simplifies the administration of these otherwise heterogeneous systems. At the same time compliance with legal regulations, for example, such as e.g. driving time limitations in the case of truck drivers, etc. can be centrally controlled and enforced simply and effectively. If, for example, the data recording client is integrated in a truck, compliance with the working hours can be enforced via the central unit by means of an interruption of ignition upon surpassing the legally prescribed working times by the user.

In an embodiment variant, captured and/or transmitted with the user data are additionally premise-specific and/or device-specific control data, access or use being granted by means of the central unit in dependence upon the control data. This has the advantage, among others, that access to the individual rooms and building sections can be granted selectively according to predefined criteria. Likewise, with devices such as e.g. machines, or vehicles, operational parameters can be checked such as state of battery, filling of the tank, tire pressure, etc., the device being released for use only under predetermined conditions and/or safety standards.

In another embodiment variant, an additional identification of the user takes place by means of a user code, which user code is entered by the user via input elements of the data recording client. This embodiment variant has the advantage, among others, that the security standard during the identification can be further increased by an additional control parameter being added which is supposed to be known only to the specific user.

In a further embodiment variant, the user code is generated by the central unit based on the identification of the user and the transmitted biometric data, and is transmitted via a second communication channel to a mobile unit of the user. In addition, the data can be transmitted encrypted or signed. The mobile unit can comprise a mobile radio device and/or a PDA and/or a mobile node of a WLAN. The advantage of this invention lies in particular in that through the combination of two separate communication channels, i.e., for example, with a LAN/WLAN connection between the data recording client and the central unit and e.g. a bidirectional communication platform, such as e.g. a mobile radio network, such as a GSM (Global System for Mobile communication), GPRS (Generalized Packet Radio Service) or UMTS (Universal Mobile Telephone System) network, the advantages of the other platform in each case can be combined in an advantageous way for the invention. In this way e.g. mobile radio networks such as GSM or UMTS networks have a high security standard. At the same time the security during identification of the user is increased by the two communication channels being independent of one another. Fraud can thereby be practically excluded.

In an embodiment variant, the additional identification by the central unit by means of user code takes place in the case where the probability of a correspondence of the transmitted biometric data to defined stored biometric data lies below the predefined threshold. This has the advantage, among others, that this embodiment variant has a kind of fall-back function and/or fall-back algorithm, which is easy to handle and cost-efficient to apply.

In still another embodiment variant, after successful additional identification of the user by means of user code, new biometric data are captured by the input unit of the data recording client, and are stored, assigned to the user, in the database. This embodiment variant has the advantage, among others, that the biometric data for a user can be continuously improved or respectively adapted. The present method is thereby both improved by way of a secure fall-back mechanism and extended by way of an expedient initialization algorithm. In particular the administration of the database can thereby be significantly simplified and optimized with respect to costs and expenditure of working time.

In a further embodiment variant, different central units access the same database with the stored biometric data of the user via a network, the database comprising means for identification and/or authorization of the different central units and means for transmission and reception of data via the network. The database can be conceived as an individual network component. This has the advantage, among others, that the recording service and identification service can be offered as a service e.g. over the Internet.

In another embodiment variant, used as the data recording client is a mobile node of a WLAN or a mobile radio device. This has the advantage, among others, that work time recording is really freely possible for the first time, even with mobile users or employees. Owing to the data recording client being a mobile unit, particular devices, such as e.g. trucks, can be checked and restricted with respect to security standards, e.g. through control of physical condition parameters (temperature, alcohol content, etc.) of the user or operational parameters (tire pressure, state of battery, filling of the tank, etc.) of the device.

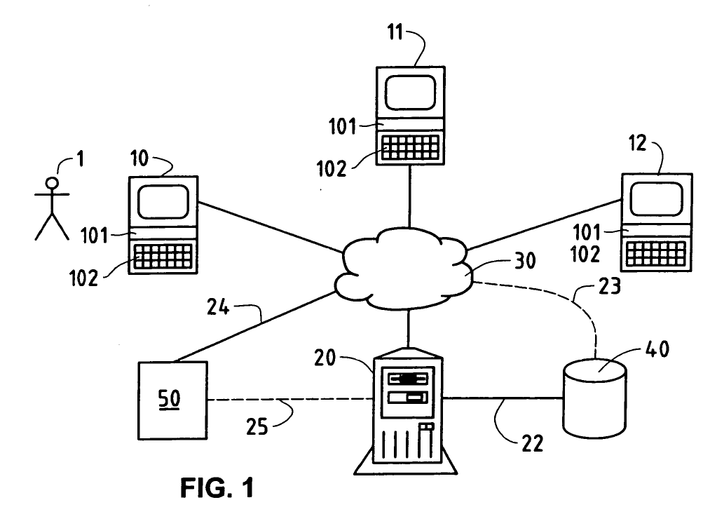

An embodiment of the present invention will be described in the following with reference to an example. The example of the embodiment is illustrated by the four attached FIGS. 1, 2, 3 and 4, showing a schematic block diagram of a work time recording system. It is thereby clear that the invention also comprises a corresponding inventive method.

FIGS. 1 to 3 illustrate a block diagram of a work time recording system, in which biometric data are captured, are transmitted to a central unit, and finally are evaluated by means of a remuneration recording module.

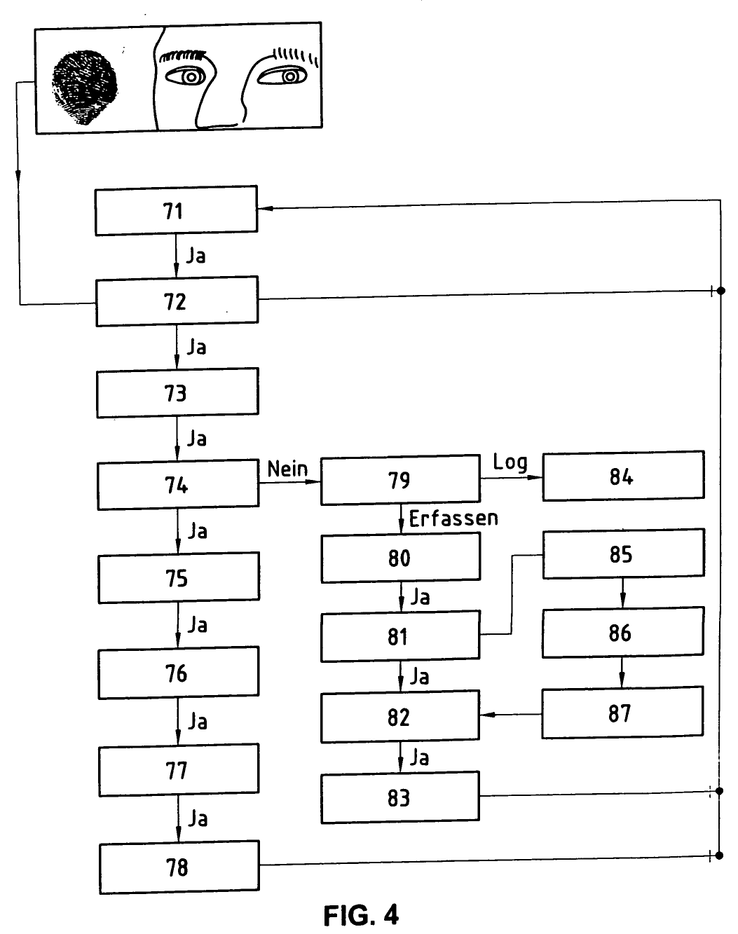

FIG. 4 shows a flow chart representing schematically the course of the method, or respectively system, according to the invention.

In FIG. 1, user data of a user 1 are captured by a data recording client 10, . . . , 16, and are transmitted to a central unit 20/21 via a first communication channel 30/31. The data recording client 10, . . . , 16 comprises an input unit 101 for capturing biometric data and/or data on physical condition of a user 1. The biometric data and/or data on physical condition of the user 1 are transmitted together with the user data via the first communication channel 30/31 to the central unit 20/21. The user data comprise e.g. place and time of capture of the biometric data or respectively of the data on physical condition. The biometric data can comprise e.g. fingerprints, iris recognition, DNA analysis, etc. The data on physical condition can comprise, for instance, body temperature, blood values (e.g. blood sugar, etc.), alcohol values, pulse, etc. of the user 1. Depending upon data acquisition, the input unit 101 of the data recording client 10, . . . , 16 possesses corresponding scanning or measuring means of the state of the art, via which the data can be measured, for instance by a corresponding API (Application Programmable Interface), and queried by the data recording client 10, . . . , 16. The data recording client 10, . . . , 16 does not necessarily have to be a fixed installed device, but can also be achieved e.g. as a mobile node of a WLAN or a mobile radio device. The connection 30, i.e. the first communication channel 30, between data recording client 10, . . . , 16 and central unit 20/21 can take place via different data channels, and not just directly over a particular communication network 30. The data can be transmitted between the data recording client 10, . . . , 16 and the central unit 20/21, e.g. also via an interface (e.g. a wireless interface such as an infrared interface or Bluetooth) to a data terminal, and from the data terminal over a communication network 30, or by means of a removable chipcard of the data recording client 10, . . . , 16 inserted in a data terminal, via this data terminal and a communication network, to the central unit 20/21. In the preferred embodiment variant, the data recording client 10, . . . , 16 and the central unit 20/21 each comprise a communication module. By means of the communication modules, data can be exchanged over the communication network 30, i.e. the first communication channel 30. The communication network 30 comprises, for example, a mobile radio network, for instance a GSM, GPRS or UMTS network, or another, e.g. satellite-based mobile radio network, or a fixed network, for example an ISDN network, the public switched telephone network, a TV or radio cable network, or an IP network (Internet Protocol). In particular in data recording clients 10, . . . , 16, which are equipped as mobile devices, the communication module comprises a mobile radio module for communication over the mobile radio network 30. By means of the communication module, in particular the above-mentioned user data can be transmitted to the central unit 20/21, for instance using GSM/SMS, GSM/USSD, GPRS or UMTS. According to the present invention, the data recording client 10, . . . , 16 is connected bidirectionally over the network 30 to a central unit 20/21. The connection between the central unit 20 and the data recording client 10, . . . , 16 can comprise a protected channel (security channel) or respectively the safety mechanisms necessary for security (encryption, limited time window, electronic signature, etc.) in the central unit 20 and the data recording client 10, . . . , 16. The download mechanisms to the data recording client 10, . . . , 16 can also comprise DAB/MExE applets. A central unit 20 can be assigned as many data recording clients 10, . . . , 16 as desired. In turn, a multiplicity of central units 20 can be assigned to a superordinate computing unit which combines the data of the central units 20. With such multi-level systems, determined at the operator level is which calculations, data compressions and/or data synchronizations are to be carried out at which level of the central units 20. This system has the advantage that complete company structures are able to be represented at system level (e.g. company/branch/cost center/section/coworker).

The user 1 is identified by the central unit 20/21 based on the user data and the biometric data, or respectively data on physical condition, by means of a user database 40. In so doing, the central unit 20/21 compares the transmitted user data and/or biometric data and/or data on physical condition with corresponding data on the users of the system stored in the user database 40. A user 1 is identified, by means of the central unit 20/21, if the probability of a correspondence of the transmitted biometric data to defined stored biometric data lies above a predefined threshold. The database 40 can be connected directly 22 to the central unit 20/21 or be achieved as a separate network component of the communication network 30, the central unit 20/21 and the database 40 communicating over the communication channel 23. With success identification, at least one user status assigned to a data record of the identified user is modified based on time (e.g. time/day/month/year) and/or place of capture of the user data and/or biometric data and/or data on physical condition of the user 1, and stored in the database. The data records of the user are transmitted to a remuneration recording module 50, and are evaluated and/or checked by means of the remuneration recording module 50. The transmission of the data records to the remuneration recording module 50 can be transmitted to the central unit 20/21, for instance periodically (e.g. using GSM/SMS, GSM/USSD, GPRS or UMTS), or upon reaching a defined value (a number of modified records and/or a particular sum of services rendered or working hours, etc) or a defined time window. The remuneration recording module 50 can be connected e.g. via an interface to a monetary institution, which releases the payment of the remuneration to the employee for the services rendered or respectively periods of work. Based on the modular structure of the system, it is clear that, in addition to the remuneration recording module 50, further computing modules (e.g. assigned in the same way as the remuneration recording module 50)<are possible>, which have functionalities based on times/controls of a company. Such modules can comprise e.g. project planning and administration, entry of services rendered, order processing, inventory control, temporal access controls to rooms and equipment, model calculations (productivity optimization of sections, productivity projections, etc.) and/or PPS (productivity monitoring), etc. In particular the system can comprise links to evaluation units such as e.g. office products, report systems (e.g. List & Label, Crystal Reports etc.). Based on the present system, enterprises and their structures can be optimized by means of planning tools in a simple way (e.g. by means of model calculations of the assignments of the employees).

As an embodiment variant, the central unit 20/21 can control in s particular access, through the central unit 20/21, of the user 1 to definable premises and/or the use of definable apparatus, based on the identification and authorization of a particular user 1. In this way systems otherwise heterogeneous, such as entry of services rendered and access controls to rooms and buildings, can be centrally administrated and controlled in a simple 1o and efficient way. Electronic locks, for example, can thus be controlled via the data recording client 10, . . . , 16 and/or central unit 20/21. At the same time compliance with legal regulations, such as e.g. driving time limits for truck drivers, etc. can be centrally controlled and enforced. If, for example, the data recording client is integrated into a truck, compliance with working times can be 15 enforced via the central unit by means of an interruption of ignition upon surpassing of the legally prescribed working hours by the user. By means of the data on physical condition, alcohol consumption by the user during working hours, for example, can be controlled and/or checked. Moreover, using the user data, premises-specific and/or device-specific control data can be 20 additionally captured and/or transmitted, the access and/or the use being controllable once again by means of the central unit 20/21 in dependence upon the control data. Access to individual rooms and sections of buildings can be selectively granted according to predefinable criteria using the control data. Likewise, in the case of devices such as e.g. machines or vehicles, operational 25 parameters can be checked, such as e.g. state of battery, filling of tank, tire pressure, etc., the device being released for use only under predefinable conditions and/or security standards. In this case the control data would then include the corresponding parameters (machines or vehicles, operational parameters such as state of battery, filling of tank, tire pressure, etc.). 30 In particular, as an embodiment variant, an additional identification can take place for identification of the user 1 by means of a user codes (ID: Identification Number), which user code is entered by the user 1 via input elements 102 of the data recording client 10, . . . , 16. The input elements 102 can comprise e.g. keyboards, graphic input means (mouse, trackball, eyetracker with Virtual Retinal Display (VRD) etc.), but also IVR (Interactive Voice Response), etc.

FIG. 3 shows another embodiment example, for further increasing the security of the system or respectively simplifying operation of the system for the user and/or operator. The user code is thereby generated by the central unit 20/21 based on the identification of the user 1 and the transmitted biometric data, and transmitted via a second communication channel 32 to a mobile unit 2 of the user 1 (see FIG. 3). The user code can also comprise e.g. an International Mobile Subscriber Identity (IMSI) or an MSISDN (Mobile Subscriber ISDN), which serves for identification in a mobile radio network, the user identification being stored, for example, in the chipcard, for instance an SIM card (Subscriber Identification Module). The mobile unit 2 can comprise one or more interfaces, in particular a device interface, for example a contactless interface, for instance an infrared interface, e.g. a High Speed Infrared (HSIR) interface, or an IrDA interface (Infrared Data Association), an inductive interface, for instance a Radio Frequency Identification (RFID) interface, a home RF (Radio Frequency) interface, a Digital European Cordless Telecommunications (DECT) interface or another Cordless Telecommunications System (CTS) interface, or a high frequency radio interface, for instance a so-called Bluetooth interface. Via such an interface, the mobile unit 2 can exchange data with external data terminals outside the mobile unit 2 which have a corresponding interface. Thus it is possible in particular to transmit the user code from the mobile unit 2 directly to a data recording client 10, . . . , 16, the data recording client 10, . . . , 16 likewise having one of the above-mentioned interfaces. The second communication channel 32 comprises, for example, a mobile radio network, for example a GSM, GPRS or UMTS network, or another, e.g. satellite-based mobile radio network, or a fixed network, for example an ISDN network, the public switched telephone network, a TV or radio cable network, or an IP network (Internet Protocol), such as a WLAN and/or the international backbone Internet. The mobile unit 2 can comprise e.g. a mobile radio device and/or a PDA and/or a mobile node of a WLAN.

It is to be pointed out that it can make sense, for certain areas of application, for the additional identification by the central unit 20/21 by means of user code to take place in the cases where the probability of a correspondence of the transmitted biometric data to defined stored biometric data lies below the predefined threshold. That is, the additional identification is used as a fall-back method or fallback algorithm. If the additional identification of the user 1 by means of user code is successful, e.g. new biometric data can be captured by means of the input unit 101 of the data recording client 10, . . . , 16, and can be stored, assigned to the user 1, in the database 40. In this way the biometric data for a user can be continuously improved or respectively adapted. This extends the present method both through a secure fall-back mechanism and through an expedient initialization algorithm. In particular the administration of the database with respect to costs and investment in working time can thereby be significantly simplified and optimized. For example, it is even possible to capture new and not registered users with new biometric data and/or data on physical condition and/or user data, since an identification by means of the mobile unit 2 can be verified. This is not possible with the conventional systems.

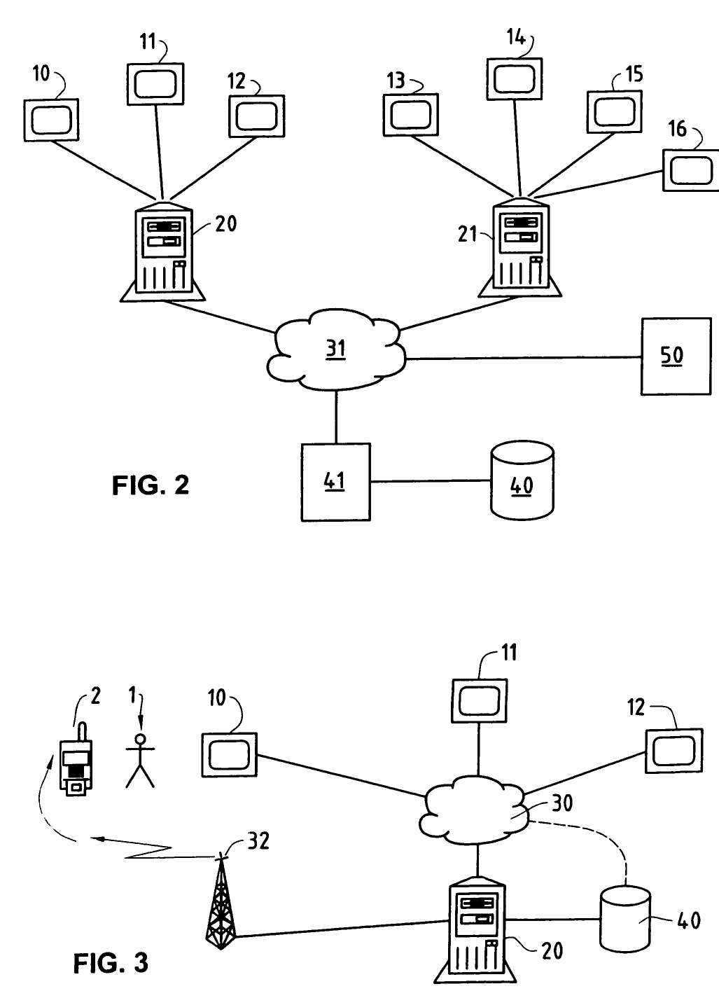

FIG. 2 shows an embodiment example, in which different central units 20/21 access the same database 40 with the stored biometric data of the user via a network 31, the database 40 comprising means 41 for identification and/or authorization of the different central units 20/21 and means 41 for transmitting and receiving data via the network 31. The database can thus be conceived as an individual network component. The work time recording method or respectively system, or the recording service and identification service can thus be offered separately as a service, e.g. over the Internet.

FIG. 4 shows schematically a possible course of the method according to the invention. A user can activate and/or initialize 71 the identification or respectively the work time recording e.g. by touching the input unit 101 of a data recording client 10, . . . , 16. In step 72, the biometric data and/or data on physical condition of the user 1 are captured by means of the input unit 101, and are transmitted together with the user data via a first communication channel 30/31 to the central unit 20/21. Based on the captured data, the user 1 is identified 73 by the central unit 20/21. If the user 1 can be identified 74, the user data (e.g. place and time) are analyzed 75, and a user status (e.g. coming/going) is determined 76. In a further step, the further data are analyzed (e.g. the data on physical condition of the user) 77, and are stored together with the other data in a user record for the user 1. If the user 1 cannot be identified 79, the process can be either aborted 84, or the user 1 can be recorded as a new user 80. If the particulars already exist stored 81 in the database 40, the method can continue directly with the capturing 82 of new biometric data and/or data on physical condition of the user 1. If the particulars are not yet present 85, the data can be recorded 86 by means of the data recording client 10, . . . , 16, and a new data record can be stored, assigned to the user 1, in the database 40. After step 86, the method likewise continues with the capturing 82 of new biometric data and/or data on physical condition of the user 1. In step 83, finally, the new biometric data are stored in the data record for the user 1, after which the method can continue e.g. with step 75, or has to be started over again at step 71 or 72.

### LIST OF REFERENCE NUMERALS

1 user
2 mobile unit
10, . . . , 16 data recording client
101 input unit
102 input elements
20/21 central unit
30/31 first communication channel
32 second communication channel
40 user database
50 remuneration recording module

1. Work time recording method, in which user data are recorded by a data recording client (10, . . . , 16), and are transmitted to a central unit (20/21) via a first communication channel (30/31), the user (1) being identified based on the user data by means of a user database (40), characterized
in that the data recording client (10, . . . , 16) records biometric data and/or data on physical condition of the user (1) by means of an input unit (101) of the data recording client (10, . . . , 16), and transmits this data together with the user data via a first communication channel (30/31) to the central unit (20/21),
in that the central unit (20/21) compares the transmitted biometric data and/or data on physical condition with biometric data and/or data on physical condition of users stored in the user database (40), and a user (1) is identified by means of the central unit (20/21), if the probability of a correspondence of the transmitted biometric data to defined stored biometric data lies above a predefined threshold,
in that with successful identification, at least one user status, assigned to a data record of the identified user (1), is modified and stored, based on time and/or place of recording of the user data, and
in that the data records of the user are transmitted to a remuneration recording module (50), and are evaluated and/or checked by means of the remuneration recording module (50).

2. Work time recording method according to claim 1, characterized in that access to definable premises and/or use of definable devices is granted to the user (1) by the central unit (20/21) only with successful identification and authorization.

3. Work time recording method according to claim 2, characterized in that captured and/or transmitted with the user data are additionally premise-specific and/or device-specific control data, access or use being granted by means of the central unit (20/21) in dependence upon the control data.

4. Work time recording method according to one of the claims 1 or 3, characterized in that an additional identification of the user (1) takes place by means of a user code, which user code is entered by the user (1) via input elements (102) of the data recording client (10, . . . , 16).

5. Work time recording method according to claim 4, characterized in that the user code is generated by the central unit (20/21) based on the identification of the user (1) and the transmitted biometric data, and is transmitted via a second communication channel (32) to a mobile unit (2) of the user (1).

6. Work time recording method according to claim 5, characterized in that the mobile unit (2) comprises a mobile radio device and/or a PDA and/or a mobile node of a WLAN.

7. Work time recording method according to one of the claims 4 to 6, characterized in that the additional identification by the central unit (20/21) by means of user code takes place in the case where the probability of a correspondence of the transmitted biometric data to defined stored biometric data lies below the predefined threshold.

8. Work time recording method according to one of the claims 4 to 7, characterized in that after successful additional identification of the user (1) by means of user code, new biometric data are captured by the input unit (101) of the data recording client (10, . . . , 16), and are stored, assigned to the user (1), in the database (40).

9. Work time recording method according to one of the claims 1 to 8, characterized in that different central units (20/21) access the same database (40) with the stored biometric data of the user via a network (31), the database (40) comprising means (41) for identification and/or authorization of the different central units (20/21) and means (41) for transmitting and receiving data over the network (31).

10. Work time recording method according to one of the claims 1 to 8, characterized in that used as data recording client (10, . . . , 16) is a mobile node of a WLAN or a mobile radio device.

11. Work time recording system, which comprises a data recording client (10, . . . , 16) for capturing user data and means for transmitting the user data over a first communication channel (30/31) to a central unit (20/21), the user (1) being identifiable based on the user data by means of a user database (40), characterized
in that the user data comprise biometric data and/or data on physical condition of the user (1), which are able to be captured by means of an input unit (101) of the data recording client (10, . . . , 16),
in that the user database (40) comprises stored biometric data and/or data on physical condition of the user (1), by means of which a user (1) is identifiable, if the probability of a correspondence of the transmitted biometric data to defined stored biometric data lies above a predefinable threshold,
in that with successful identification at least one user status assigned to the data record is modifiable based on time and/or place of capture of the user data, and
in that the monitoring and time recording system comprises a remuneration recording module (50) for periodic evaluation and/or checking of the data records of the users.

12. Work time recording system according to claim 11, characterized in that the monitoring and time recording system comprises access control modules, by means of which access to definable premises and/or use of definable devices is granted to the user (1) by the central unit (20/21) only with successful identification and authorization.

13. Work time recording system according to one of the claims 11 or 12, characterized in that the user data additionally comprise premise-specific and/or device-specific control data, access and/or use being determinable by means of the central unit (20/21) in dependence upon the control data.

14. Work time recording system according to one of the claims 10 or 11, characterized in that the additional identification of the user (1) comprises a user code, which user code is entered by the user (1) via input elements (102) of the data recording client (10, . . . , 16).

15. Work time recording system according to claim 14, characterized in that the central unit (20/21) comprises means for generating user codes and a second communication channel (32) for transmitting the user code to a mobile unit (2) of the user (1).

16. Work time recording system according to claim 15, characterized in that the mobile unit (2) comprises a mobile radio device and/or a PDA and/or a mobile node of a WLAN.

17. Work time recording system according to one of the claims 14 to 16, characterized in that the additional identification by means of user code by the central unit (20/21) takes place in the case where the probability of a correspondence of the transmitted biometric data with defined stored biometric data lies below the predefined threshold.

18. Work time recording system according to claim 15, characterized in that, after successful additional identification of the user (1) by means of user code, new biometric data are able to be captured by the input unit (101) of the data recording client (10, . . . , 16), and are storable, assigned to the user (1), in the central unit (20/21).

19. Work time recording system according to one of the claims 11 to 18, characterized in that the system comprises means for bidirectional access to the database (40) by different central units (20/21) via the networks (31), the database (40) comprising means (41) for identification and/or authorization of the different central units (20/21) and means (41) for transmitting and receiving data over the network (31).

20. Work time recording system according to one of the claims 1 to 8, characterized in that the data recording client (10, . . . , 16) is integrated in a mobile node of a WLAN or a mobile radio device.
